(19) United States
(12) Patent Application Publication
(10) Pub. No.: US 2023/0162382 A1
(43) Pub. Date: May 25, 2023

(54) METHOD AND SYSTEM FOR DETERMINING LIDAR INTENSITY VALUES, AND TRAINING METHOD

(71) Applicant: dSPACE GmbH, Paderborn (DE)

(72) Inventors: Daniel HASENKLEVER, Paderborn (DE); Jahn HEYMANN, Paderborn (DE)

(73) Assignee: dSPACE GmbH, Paderborn (DE)

(21) Appl. No.: 17/993,687

(22) Filed: Nov. 23, 2022

(30) Foreign Application Priority Data
Nov. 23, 2021 (DE) 10 2021 130 662.0
Nov. 23, 2021 (EP) 21209972.5

(51) Int. Cl. G06T 7/521; G01S 7/4861; G01S 7/4913; G01S 17/00; G06V 10/60; G06V 10/50

(52) U.S. Cl. CPC G06T 7/521; G01S 7/4861; G01S 7/4913; G01S 17/006; G06V 10/60; G06V 10/507; G01S 17/86

(57) ABSTRACT

A computer-implemented method as well as a system for determining intensity values of pixels of distance data of the pixels generated by a simulation of a 3D scene, including an assignment of a first confidence value to each of the first initial values of the pixels and/or a second confidence value to each of the second intensity values of the pixels, and including a calculation of third, in particular corrected, intensity values of the pixels, using the confidence values assigned to each of the first intensity values and/or second intensity values. The invention also relates to a computer-implemented method for providing a trained machine learning algorithm as well as to a computer program.

This nonprovisional application claims priority under 35 U.S.C. § 119(a) to German Patent Application No. 10 2021 130 662.0, which was filed in Germany on Nov. 23, 2021, and European Patent Application No. 21209972.5, which was filed in Europe on Nov. 23, 2021, and which are both herein incorporated by reference.

### BACKGROUND OF THE INVENTION

### Field of the Invention

The present invention relates to a computer-implemented method for determining intensity values of pixels of distance data of the pixels generated by a simulation of a 3D scene.

The invention further relates to a method for providing a trained machine learning algorithm for determining intensity values of pixels of distance data of the pixels generated by a simulation of a 3D scene.

The invention also relates to a system for determining intensity values of pixels of distance data of the pixels generated by a simulation of a 3D scene. The present invention additionally relates to a computer program.

### Description of the Background Art

EP 3 876 157 (which corresponds to US 2022/0326386), US 2020/0301799, EP 3 637 138, CN 104 268 323, and Tim Allan Wheeler et al.: “Deep Stochastic Radar Models”, ARXIV.org, Cornell University Librry, 201 Olin Library Cornell University Ithaca, N.Y. 14853, Jan. 31, 2017, XP080752626, DOI: 10.1109/IVS.2017.7995697, are all herein incorporated by reference.

To generate LIDAR data, complex test drives in real surroundings are generally necessary for obtaining the corresponding data. It is therefore desirable to generate LIDAR sensor data synthetically. A LIDAR point cloud essentially contains two features: the intensity of objects and the distance of objects to the LIDAR sensor.

The LIDAR intensity is recorded as the return beam intensity of a laser beam. The LIDAR intensity may vary, for example with the constitution of the surface object reflecting the laser beam. A low number represents a low reflectivity, a high number represents a high reflectivity. The intensity of the returning laser beam may also be influenced by the angle of incidence (scanning angle), the range, the surface composition, the roughness, and the moisture content.

While the distance may be comparatively easily modeled by the geometry, the intensity is based on the reflectivity values of materials, which, in turn, are dependent on the angle of incidence and the type of reflection.

To be able to model the intensity in a virtual environment, the material properties of the objects to be modeled must therefore be calibrated. Calibrating materials is cost-intensive, on the one hand, and possible only in a finite quantity, on the other hand.

At the same time, modeling measurement noise and sensor noise profiles in a model-based manner is extremely complex. The reality of the synthetic data is limited by factors such as realistic surface structure, noise, multipath dispersal, and lack of knowledge about material properties.

There is consequently a need to improve existing methods and systems for generating synthetic sensor data of a surroundings capturing sensor, in particular a LIDAR sensor, of a vehicle in such a way that a simplified, more efficient, and more cost-effective generation of the virtual vehicle surroundings is made possible.

### SUMMARY OF THE INVENTION

It is therefore an object of the present invention to provide a computer-implemented method, a system, a computer-implemented training method, as well as a computer program, which permit a simplified, more efficient, and more cost-effective generation of synthetic sensor data of a surroundings capturing sensor, in particular a LIDAR sensor.

According to an exemplary embodiment of the invention, the object is achieved by a computer-implemented method for determining intensity values of pixels of distance data of the pixels generated by a simulation of a 3D scene.

The method comprises a provision of the distance data of the pixels as well as an application of a machine learning algorithm to the distance data, which outputs first intensity values of the pixels.

The method further comprises an application of a light beam tracking method to the distance data for determining second intensity values of the pixels, using precaptured, in particular calibrated, material reflection values for a first plurality of pixels, and/or a statistical method for a second plurality of pixels.

The method also comprises an assignment of a first confidence value to each of the first intensity values of the pixels and/or a second confidence value to each of the second intensity values of the pixels, and a calculation of third, in particular corrected, intensity values of the pixels, using the confidence values assigned to each of the first intensity values and/or second intensity values.

The invention additionally relates to a system for determining intensity values of pixels of distance data of the pixels generated by a simulation of a 3D scene.

The system provides the distance data of the pixels as well as a first control unit, which is configured to apply a machine learning algorithm, which outputs first intensity values of the pixels, to the distance data.

The system also comprises a second control unit, which is configured to apply a light beam tracking method to the distance data for determining second intensity values of the pixels, using precaptured, in particular calibrated, material reflection values for a first plurality of pixels, and/or a statistical method for a second plurality of pixels.

The system further comprises a component for assigning a first confidence value to each of the first intensity values of the pixels and/or a second confidence value to each of the second intensity values of the pixels, and a processor for calculating third, in particular corrected, intensity values of the pixels, using the confidence values assigned to each of the first and/or second intensity values.

The invention furthermore relates to a method for providing a computer-implemented method for providing a trained machine learning algorithm for determining intensity values of pixels of distance data of the pixels generated by a simulation of a 3D scene.

The method comprises a receipt of a first training data set of distance data of the pixels and a receipt of a second training data set of intensity values of the pixels.

The method also comprises a training of the machine learning algorithm by an optimization algorithm, which calculates an extreme value of a loss function for determining the intensity values of the pixels.

One idea of the present invention is to obtain intensity values of the pixels from the simulation by applying a machine learning algorithm to the distance data, which outputs first intensity values of the pixels, and by applying a light beam tracking method to the distance data for determining second intensity values of the pixels, using precaptured, in particular calibrated, material reflection values for a first plurality of pixels and/or a statistical method for a second plurality of pixels.

By assigning a first confidence value to each of the first intensity values of the pixels and/or a second confidence value to each of the second intensity values of the pixels, the first intensity value may be advantageously used where the first confidence value is high, and the second intensity value may be used where the second confidence value is high.

Third, in particular corrected, intensity values of the pixels may thus be calculated using the confidence values assigned to each of the first intensity values and/or second intensity values, which results in an improved accuracy of the intensity values of the pixels.

According to an example, it is provided that the third, in particular corrected, intensity values of the pixels are calculated by forming a weighted mean value from a sum product having a first product of the particular first intensity value and the assigned first confidence value, and having a second product of the particular second intensity value and the assigned second confidence value, divided by a sum of the confidence values of the particular pixels.

Physical properties and distance information may thus advantageously be each provided with a weighting, and weightings may be taken into account when calculating or mixing the intensity values.

It may also be provided that a higher confidence value can be assigned to the first intensity values determined for the first plurality of pixels, using the precaptured, in particular calibrated, material reflection values, than is assigned to the second intensity values determined by the statistical method for the second plurality of pixels.

Due to the higher accuracy of the calibrated material reflection values, compared to the intensity values determined by the statistical method, a higher confidence value is thus attributed to the calibrated material reflection values.

Camera image data of the pixels, in particular RGB image data thereof, can be provided, the distance data of the pixels and the camera image data of the pixels being provided by simulating the 3D scene. The provision of the camera image data advantageously makes it possible to determine more precise distance data, which permits a more accurate determination of the reflectivity values.

The simulation of the 3D scene can generate raw distance data of the pixels as a 3D point cloud, which are transformed into 2D spherical coordinates by an image processing method and are provided as, in particular 2D, distance data of the pixels.

The further processing of the distance data by the machine learning algorithm and the light beam tracking method may thus take place, using data which is present in an optimal format for the particular algorithm.

The machine learning algorithm and the light beam tracking method process the provided distance data of the pixels simultaneously. The simultaneous processing of the data by the particular algorithms thus permits an efficient method for determining intensity values of pixels of distance data of the pixels generated by the simulation of the 3D scene.

The calculated third, in particular corrected, intensity values of the pixels can be used in the simulation of the 3D scene, in particular in a traffic simulation. The simulation of the 3D scene may thus advantageously be made possible using intensity values of pixels which were generated on the basis of the distance information of the pixels.

Precaptured, in particular calibrated, material reflection values for the first plurality of pixels can be determined by a bidirectional reflection distribution function. Exact material reflection values may thus be advantageously determined in each case for pixels having known intensity values.

The first training data set can include distance data of the pixels captured by a surroundings capturing sensor, in particular a LIDAR sensor, and the second training data set includes intensity values of the pixels captured by the surroundings capturing sensor, or the first training data set includes distance data of the pixels captured by a surroundings capturing sensor, in particular a LIDAR sensor and generated by a simulation of a 3D scene, and the second training data set includes intensity values of the pixels captured by the surroundings capturing sensor and generated by a simulation of a 3D scene.

Mixing real and synthetically generated training data makes it possible to achieve the fact that the trained machine learning algorithm has less of a mismatch relating to the synthetic distance data originating, in particular from the simulation and used for the inference.

The first training data set can include camera image data, in particular RGB image data, of the pixels captured by a camera sensor. The provision of the camera image data advantageously makes it possible to determine more precise distance data, which thus permits a more accurate determination of the reflectivity values.

The first training data set can include distance data of the pixels, and the second training data set includes intensity values of the pixels, under different environmental conditions in each case, in particular different weather conditions, visibility conditions, and/or times of day.

The provision of the distance data of the pixels as well as the intensity values of the pixels under different environmental conditions advantageously makes it possible to train a more robust machine learning algorithm for determining the intensity values of the pixels.

An unmonitored domain adaptation can be carried out, using non-annotated data of the distance data of the pixels and/or the intensity values of the pixels. An improvement of the training may thus be advantageously made possible by a domain adaptation of the input data with respect to real and artificial input sensor data. The domain adaptation uses back-propagation of a loss of a domain label to select a feature for which the particular domains are less able to be differentiated.

The features of the method described herein are applicable to a multiplicity of virtual environments, for example the testing of autonomous motor vehicles, aircraft, and/or spacecraft.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows a flowchart of a computer-implemented method for determining intensity values of pixels of distance data of the pixels generated by a simulation of a 3D scene according to one preferred specific embodiment of the invention;

FIG. 2 shows a schematic representation of a system for determining intensity values of pixels of distance data of the pixels generated by a simulation of a 3D scene according to the preferred specific embodiment of the invention; and

FIG. 3 shows a flowchart of the method for providing a trained machine vision algorithm for determining intensity values of pixels of distance data of the pixels generated by a simulation of a 3D scene according to the preferred specific embodiment of the invention.

### DETAILED DESCRIPTION

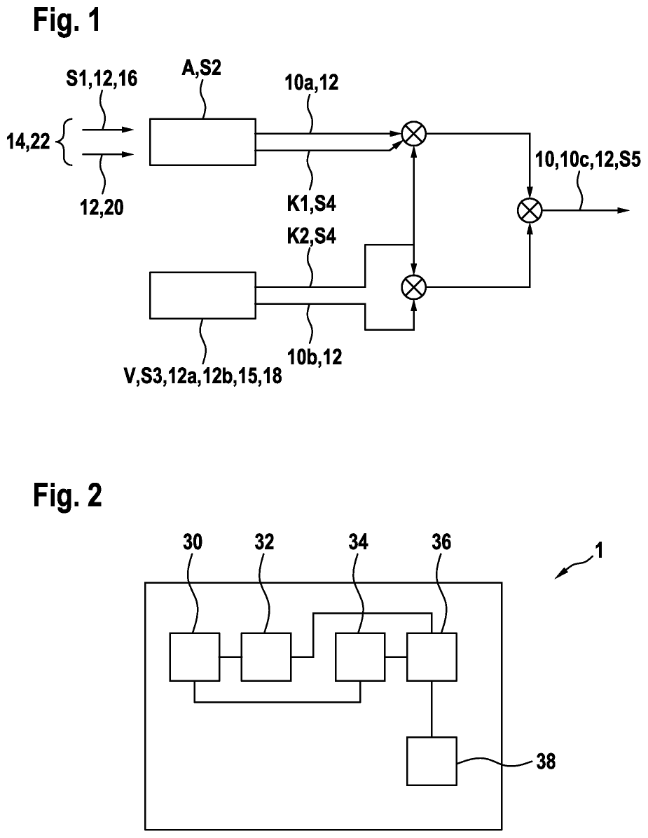

The method shown in FIG. 1 for determining intensity values 10 of pixels 12 of distance data 16 of pixels 12 by a simulation 14 of a 3D scene comprises a provision 51 of distance data 16 of pixels 12 as well as an application S2 of a machine learning algorithm A to distance data 16, which outputs first intensity values 10a of pixels 12.

The method further comprises an application S3 of a light beam tracking method V to distance data 16 for determining second intensity values 10b of pixels 12, using precaptured, in particular calibrated, material reflection values 15 for a first plurality of pixels 12a and/or a statistical method 18 for a second plurality of pixels 12b.

The method also comprises an assignment S4 of a first confidence value K1 to each of first intensity values 10a of pixels 12 and/or a second confidence value K2 to each of second intensity values 10b of pixels 12, and a calculation S5 of third, in particular corrected, intensity values 10c of pixels 12, using confidence values K1, K2 assigned to each of first intensity values 10a and/or second intensity values 10b.

Third, in particular corrected, intensity values 10c of pixels 12 are calculated by forming a weighted mean value from a sum product having a first product of particular first intensity value 10a and assigned first confidence value K1, and a second product of particular second intensity value 10b and assigned second confidence value K2, divided by a sum of confidence values K1, K2 of particular pixels 12.

Alternatively, the particular pairs made up of first intensity value 10a and assigned first confidence value K1 as well as second intensity value 10b and assigned second confidence value K2 may be calculated using an alternative statistical method for determining corrected intensity values 10c of pixels 12.

A higher confidence value K1, K2 is assigned to second intensity values 10b determined for the first plurality of pixels 12a, using precaptured, in particular calibrated, material reflection values 15, than is assigned to second intensity values 10b determined for the second plurality of pixels 12b using statistical method 18.

Camera image data 20, in particular RGB image data, of pixels 12 are also provided. Distance data 16 of pixels 12 and camera image data 20 of pixels 12 are provided using simulation 14 of the 3D scene.

Simulation 14 of the 3D scene generates raw distance data 16 of pixels 12 as a 3D point cloud, which are transformed into 2D spherical coordinates using an image processing method 22 and are provided as, in particular 2D, distance data 16 of pixels 12. Machine learning algorithm A and light beam tracking method V process provided distance data 16 of pixels 12 simultaneously.

Calculated third, in particular corrected, intensity values 10 of pixels 12 are used in simulation 14 of the 3D scene, in particular in a traffic simulation 14. Precaptured, in particular calibrated, material reflection values 15 for the first plurality of pixels 12a are determined by a bidirectional reflection distribution function.

FIG. 2 shows a schematic representation of a system for determining intensity values of pixels of distance data of the pixels generated by a simulation of a 3D scene according to the preferred specific embodiment of the invention.

The system comprises a determinator 30 for providing distance data 16 of pixels 12 as well as a first control unit 32, which is configured to apply a machine learning algorithm A, which outputs first intensity 10 values of pixels 12, to distance data 16.

The system further comprises a second control unit 34, which is configured to apply a light beam tracking method V to distance data 16 for determining second intensity values 10 of pixels 12, using precaptured, in particular calibrated, material reflection values 15 for a first plurality of pixels 12a and/or using a statistical method 18 for a second plurality of pixels 12b.

The system further comprises an assignor 36 for assigning a first confidence value K1 to each of first intensity values 10 of pixels 12 and/or a second confidence value K2 to each of second intensity values 10 of pixels 12, as well as a processor 38 for calculating third, in particular corrected, intensity values 10 of pixels 12, using confidence values K1, K2 assigned to each of first and/or second intensity values 10.

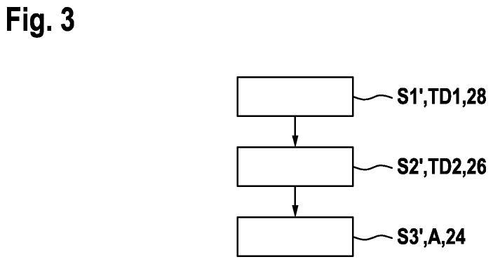

FIG. 3 shows a flowchart of the method for providing a trained machine vision algorithm for determining intensity values of pixels of distance data of the pixels generated by a simulation of a 3D scene according to the preferred specific embodiment of the invention.

The method comprises a receipt S1′ of a first training data set TD1 of distance data 16 of pixels 12 as well as a receipt S2′ of a second training data set TD2 of intensity values 10 of pixels 12.

The method also comprises a training S3′ of machine learning algorithm A by an optimization algorithm 24, which calculates an extreme value of a loss function for determining intensity values 10 of pixels 12.

First training data set TD1 includes distance data 16 of pixels 12 captured by a surroundings capturing sensor 26, in particular a LIDAR sensor, and the second training data set includes intensity values 10 of pixels 12 captured by surroundings capturing sensor 26.

Alternatively, first training data set TD1 may include distance data 16 of pixels 12 captured by a surroundings capturing sensor 26, in particular, a LIDAR sensor and generated by a simulation 14 of a 3D scene. Second training data set TD2 further includes intensity values 10 of pixels 12 captured by surroundings capturing section 26 and generated by a simulation 14 of a 3D scene.

First training data set TD1 additionally includes camera image data 20, in particular RGB image data, of pixels 12 captured by a camera sensor 28.

First training data set TD1 includes distance data 16 of pixels 12, and second training data set TD2 includes intensity values 10 of pixels 12, under different environmental conditions in each case, in particular different weather conditions, visibility conditions, and/or times of day.

An unmonitored domain adaptation is also carried out, using non-annotated data of distance data 16 of pixels 12 and/or intensity values 10 of pixels 12.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A computer-implemented method for determining intensity values of pixels of distance data of the pixels generated by a simulation of a 3D scene, the method comprising:
providing the distance data of the pixels;
applying a machine learning algorithm to the distance data, which outputs first intensity values of the pixels;
applying a light beam tracking method to the distance data to determine second intensity values of the pixels using precaptured or calibrated material reflection values for a first plurality of pixels and/or using a statistical method for a second plurality of pixels;
assigning a first confidence value to each of the first intensity values of the pixels and/or a second confidence value to each of the second intensity values of the pixels; and
calculating third corrected intensity values of the pixels using the confidence values assigned to each of the first intensity values and/or the second intensity values.

2. The computer-implemented method according to claim 1, wherein the third corrected intensity values of the pixels are calculated by forming a weighted mean value made up of a sum product having a first product of the particular first intensity value and the assigned first confidence value and a second product of the particular second intensity value and the assigned second confidence value divided by a sum of the confidence values of the particular pixels.

3. The computer-implemented method according to claim 1, wherein a higher confidence value is assigned to the second intensity values determined for the first plurality of pixels using the precaptured, in particular calibrated, material reflection values, than is assigned to the second intensity values determined for the second plurality of pixels using the statistical method.

4. The computer-implemented method according to claim 1, wherein camera image data, in particular RGB image data, of the pixels are provided, the distance data of the pixels and the camera image data of the pixels being provided by the simulation of the 3D scene.

5. The computer-implemented method according to claim 1, wherein the simulation of the 3D scene generates raw distance data of the pixels as a 3D point cloud, which are transformed by an image processing method into 2D spherical coordinates and are provided as, in particular 2D, distance data of the pixels.

6. The computer-implemented method according to claim 1, wherein the machine learning algorithm and the light beam tracking method process the provided distance data of the pixels simultaneously.

7. The computer-implemented method according to claim 1, wherein the calculated third, in particular corrected, intensity values of the pixels are used in the simulation of the 3D scene, in particular in a traffic simulation.

8. The computer-implemented method according to claim 1, wherein precaptured or calibrated material reference values for the first plurality of pixels are determined by a bidirectional reflection distribution function.

9. A computer-implemented method for providing a trained machine learning algorithm to determine intensity values of pixels of distance data of the pixels generated by a simulation of a 3D scene, the method comprising:
receiving a first training data set of distance data of pixels;
receiving a second training data set of intensity values of the pixels; and
training the machine learning algorithm using an optimization algorithm, which calculates an extreme value of a loss function for determining the intensity values of the pixels.

10. The computer-implemented method according to claim 9, wherein the first training data set includes distance data of the pixels captured by a surroundings capturing sensor, in particular a LIDAR sensor, and the second training data set includes intensity values of the pixels captured by the surroundings capturing sensor, or the first training data set includes distance data of the pixels captured by a surroundings capturing sensor, in particular a LIDAR sensor and generated by a simulation of a 3D scene, and the second training data set includes intensity values of the pixels captured by the surroundings capturing sensor and generated by a simulation of a 3D scene.

11. The computer-implemented method according to claim 9, wherein the first training data set includes camera image data, in particular RGB image data, of the pixels captured by a camera sensor.

12. The computer-implemented method according to claim 9, wherein the first training data set includes distance data of the pixels, and the second training data set includes intensity values of the pixels under different environmental conditions in each case, in particular different weather conditions, visibility conditions, and/or times of day.

13. The computer-implemented method according to claim 12, wherein an unmonitored domain adaptation is carried out, using non-annotated data of the distance data of the pixels and/or the intensity values of the pixels.

14. A system to determine intensity values of pixels of distance data of the pixels generated by a simulation of a 3D scene, the system comprising:
a determinator to provide the distance data of the pixels;
a first control unit configured to apply a machine learning algorithm and to output first intensity values of the pixels to the distance data;
a second control unit configured to apply a light beam tracking method to the distance data to determine second intensity values of the pixels using precaptured or calibrated material reflection values for a first plurality of pixels and/or using a statistical method for a second plurality of pixels;
an assignor to assign a first confidence value to each of the first intensity values of the pixels and/or a second confidence value to each of the second intensity values of the pixels; and
a processor to calculate third, in particular corrected, intensity values of the pixels using the confidence values assigned to each of the first and/or second intensity values.

15. A computer program including program code for carrying out the method according to claim 1 when the computer program is executed on a computer.
